(19) United States
(12) Patent Application Publication
(10) Pub. No.: US 2007/0216157 A1
(43) Pub. Date: Sep. 20, 2007

(54) Gas Riser Apparatus, And Method And Apparatus For Making Same

(75) Inventor: Joseph A. Tarquini, Rockford, IL (US)

Correspondence Address: REINHART BOERNER VAN DEUREN P.C., 2215 PERRYGREEN WAY, ROCKFORD, IL, 61107, US

(73) Assignee: Chicago Fittings Corporation, Belvidere, IL (US)

(21) Appl. No.: 11/685,901

(22) Filed: Mar. 14, 2007

Related U.S. Application Data
(60) Provisional application No. 60/782,194, filed on Mar. 14, 2006.

(51) Int. Cl. F16L 33/00

(52) U.S. Cl. 285/256

(57) ABSTRACT

A gas riser apparatus, and methods for making and using a gas riser apparatus, are provided, through use of a transition fitting having a first end thereof configured for operative attachment to above-ground gas piping, a second end thereof adapted for operative attachment to an underground plastic pipe, and a shouldered peripheral portion thereof adapted for swaged connection thereto of an above-ground end of a protective casing of the riser in a manner which precludes having the protective casing function as a gas-carrying member of the riser.

### CROSS-REFERENCE TO RELATED PATENT APPLICATIONS

This patent application claims the benefit of U.S. Provisional Patent Application No. 60/782,194, filed Mar. 14, 2006, the disclosure and teachings of which are incorporated herein in their entireties, by reference.

### FIELD OF THE INVENTION

This invention relates to gas risers for connecting underground gas service lines, and particularly plastic service lines, with above-ground meters and the like.

### BACKGROUND OF THE INVENTION

Flammable gases, such as natural gas and propane, are typically routed through underground supply lines between buildings and a source of gas, such as a gas main or storage tank, for safety purposes. For several decades, thermoplastic tubing has been the preferred method of making such underground connections, because such plastic tubing eliminates problems with corrosion encountered with the use of metal underground gas piping, in previous times.

Where the plastic gas supply tubing emerges from the ground, for connection to gas meters and regulators, and the like, common sense and government regulations require that a special connection apparatus, known in the industry as a gas riser, be used for completing the necessary connections. One end of such a gas riser is adapted for connection to the above-ground metal piping, and the other end of the riser is adapted for connection to the underground plastic pipe. The gas riser includes a protective casing installed around the plastic gas supply tube, from the point of the above-ground connection, to an underground point on the plastic tube spaced several feet from the above-ground point of connection. The gas riser, therefore, protects the plastic tube from being damaged by contact above-ground with lawnmowers, grass trimmers, and the like, and also provides protection extending along the length of the riser underground.

Although the particular configuration of a given gas riser will be determined by applicable government regulations, and preferences of a particular gas supplier, such risers are generally required to be L-shaped, with a lower leg of the L extending substantially horizontally underground for receiving the plastic tube from the source of the gas, and the second leg extending substantially vertically out of the ground for connection to a gas regulator, meter, or other piping attached to the building being supplied with gas.

In some gas riser installations the entirety of the vertical and horizontal legs of the protective casing of the riser are rigid. In other gas riser installations, regulations and customer preferences dictate that at least a portion of the vertically extending leg of the riser be formed from a rigid section of metal pipe, with the remainder of the risers sometimes being provided by a flexible metallic conduit attached to the lower end of the rigid section. In other gas riser applications, the rigid pipe section is eliminated, and the entire protective casing of the riser is formed from a flexible metal conduit material.

The underground end of a gas riser typically includes an environmental seal, having a hole through which the gas supply tubing may pass. The above-ground end of the riser typically includes a threaded fitting, for connecting the riser to a gas meter, regulator, or building piping, in such a manner that the plastic tubing is not exposed.

In one commonly utilized prior approach to constructing gas risers, the above-ground end of the protective casing of the riser is configured to also function as a gas-carrying member, in addition to providing physical protection to the portion of the plastic tube within the protective casing. Such prior risers typically rely upon achieving a gas-tight seal between the end of the plastic pipe and the inside wall of the protective casing, or an end fitting which is joined to the above-ground end of the protective casing by some means, such as by welding, for example, with the juncture between the plastic tube and the protective casing and/or fitting being sealed by some form of an elastomeric gasket. U.S. Patent Application No. 2003/0214133 A1, to Robison et al., and the following U.S. patents are illustrative of such prior approaches: U.S. Pat. No. 6,896,297 B2, to Hall; U.S. Pat. No. 6,237,963 B1, to Hall; and U.S. Pat. No. 4,801,159, to Sehom.

Such prior gas risers have proved to be undesirably difficult to manufacture, in a low-cost and reliable manner, due to the necessity for ensuring that a gas-tight seal is formed with the protective casing. Also, in prior risers such those described in the '297 and '963 patents to Hall, and the '159 patent to Sehom, it has been necessary to grip the exterior surface of the protective casing with a gripping-type-jaw tool, such as a pipe wrench, during connection of the riser to the above-ground piping system or meter. Such gripping-jaw-type tools tend to cut through protective coatings on the outside surface of the riser, and bite deeply into the protective casing, leaving a visible and unprotected scar, which quickly rusts when exposed to the environment. Risers having a fitting welded onto the above-ground end of the riser also create difficulties and limitations, during manufacture of the riser, with regards to applying a proper corrosion resistant coating to the protective casing.

It is desirable, therefore, to provide an improved gas riser. It is particularly desirable to provide an improved gas riser which does not require that the protective casing of the riser function as a gas-carrying member. It is also desirable that the improved riser have a configuration that obviates the need for use of gripping-jaw-type tools during installation of the riser, in a construction that facilitates manufacturing processes such as application of corrosion resistant coatings to the protective casing of the riser. It is further desirable that various embodiments of the improved gas riser be capable of meeting the requirements of applicable standards, such as ASTM, International Standard, F 1973-02, titled: Standard Specification for Factory Assembled Anodeless Risers and Transition Fittings in Polyethylene (PE) and Polyamide 11 (PA11) Fuel gas Distribution Systems.

### BRIEF SUMMARY OF THE INVENTION

The invention provides an improved gas riser apparatus, and methods for making and using such an improved gas riser apparatus, through use of a transition fitting having a first end thereof configured for operative attachment to above-ground gas piping, a second end thereof adapted for operative attachment to an underground plastic pipe, and a shouldered peripheral portion thereof adapted for swaged connection thereto of an above-ground end of a protective casing of the riser in a manner which precludes having the protective casing function as a gas-carrying member of the riser. In some embodiments of the invention, the process of swaging the above-ground end of the of the protective casing to the transition fitting is accomplished without breaking through a protective coating applied to the protective casing, prior to swaging the above-ground end of the protective casing onto the peripheral portion of the casing.

In one form of the invention, a gas riser apparatus, for transporting gas from an underground plastic pipe to above-ground metal piping includes a tubular-shaped protective casing, a riser tube disposed within the protective casing, a transition fitting, and a swaging collar. The tubular-shaped protective casing includes first and second ends thereof, and in similar fashion, the riser tube defines first and second ends respectively thereof. The transition fitting includes a fluid passage therethrough, with the swaging collar being disposed about the first end of the riser tube within the protective casing.

The transition fitting includes a first end thereof, configured for threaded engagement with the above-ground metal piping, and a second end thereof configured as a spigot for insertion into the first end of the riser tube. The transition fitting further includes a shouldered peripheral portion thereof for insertion into the first end of the casing, to a depth at which a shoulder of the shouldered peripheral portion substantially abuts the first end of the protective casing. The fluid passage in the transition fitting extends through the spigot and provides fluid communication between the first and second ends of the transition fitting.

The first end of the riser tube is operatively joined to the spigot by a first swaged joint formed by swaging the swaging collar inward to partially compress the first end of the riser tube between the spigot and the swaging collar.

The transition fitting is fixedly attached to the first end of the protective casing by a second swaged joint, formed by swaging a portion of the protective casing against the shouldered peripheral portion of the transition fitting.

A gas riser apparatus, according the invention, may further include a seal-element disposed between the spigot and the first end of the riser tube. The spigot may include an outwardly opening annular groove therein, with the seal-element comprising a compliant O-ring substantially disposed in the annular groove.

In some forms of a gas riser apparatus, according to the invention, substantially faying surfaces of one, or both, of the shouldered peripheral portion, and/or the portion of the protective casing forming the second swaged joint, further include one or more anti-rotation feature(s) for precluding rotation of the transition fitting within the protective casing. The faying surface of the shouldered peripheral portion of the transition fitting may be at least partially knurled, to thereby form at least one of the one or more anti-rotation feature(s).

The second end of the riser tube may extend beyond the second end of the protective casing, with the second end of the protective casing being operatively connected to an outer surface of the riser tube by a third swaged joint in which a portion of the protective casing adjacent the second end of the protective casing is swaged inward about the riser tube. A gas riser apparatus, according to the invention, may also include an environmental seal operatively disposed between the outer surface of the riser tube and the protective casing, with the environmental seal being fixedly held in place by the third swag joint.

Various aspects and elements of the invention may be utilized in practicing the invention with gas risers having completely rigid protective casings, partially rigid protective casings, or flexible protective casings.

The invention may also take the form of a method for manufacturing, and/or utilizing a apparatus according to the invention.

Some forms of the invention meet the requirements of applicable standards, such as ASTM, International Standard, F 1973-02, titled: Standard Specification for Factory Assembled Anodeless Risers and Transition Fittings in Polyethylene (PE) and Polyamide 11 (PA11) Fuel gas Distribution Systems.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 shows a first exemplary embodiment of a gas riser, according to the invention, in which the gas riser includes a rigid protective casing which is not used as a gas-carrying member;

FIG. 2 is a partial cross-sectional view of the exemplary embodiment of the gas riser of FIG. 1, illustrating details of construction and connection of various components of the exemplary embodiment; and

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

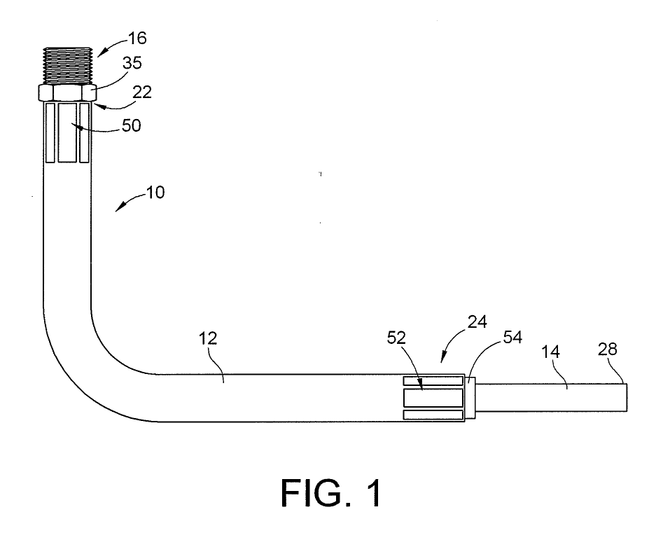

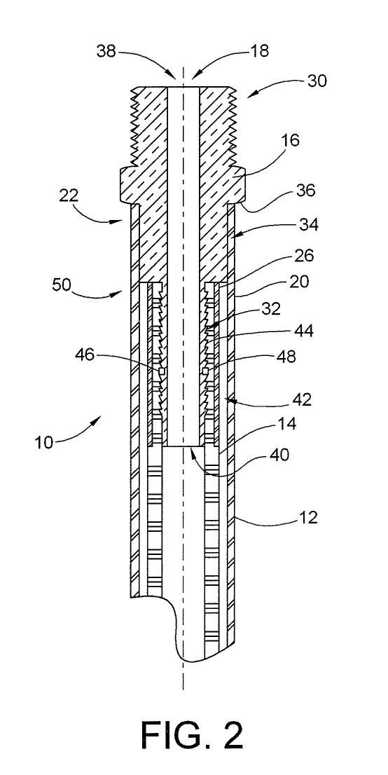

FIGS. 1 and 2 show a first exemplary embodiment of a gas riser apparatus 10, according to the invention, for transporting a fuel gas, such as natural gas or propane, for example, in gaseous form, from an underground plastic supply pipe (not shown) to above-ground metal piping (not shown). The exemplary embodiment of the gas riser apparatus 10 includes a tubular-shaped protective casing 12, a riser tube 14 disposed within the protective casing 10, a transition fitting 16 having a fluid passage 18 extending therethrough, and a swaging collar 20. The protective casing 12 has first and second ends 22, 24 thereof and the riser tube similarly defines first and second ends 26, 28 thereof, with the swaging collar 20 being disposed about the first end 26 of the riser tube 14, within the protective casing 12.

The transition fitting 16 has a first end 30 thereof, which is configured to include male NPT pipe threads for threaded engagement with the above-ground metal piping. A second end of the transition fitting 16 is configured as a spigot 32 for insertion into the first end 26 of the riser tube 14. The transition fitting 16 also includes a shouldered peripheral portion 34 thereof, adapted for insertion into the first end 22 of the casing 12 to a depth at which a shoulder in the form of the lower edge of a hex-shaped wrenching portion 35 of the transition fitting 16 substantially abuts the first end 22 of the protective casing 12.

As will be understood through an examination of FIG. 2, the fluid passage 18 through the transition fitting 16 extends through the spigot 32, at the second end of the transition fitting 16, to thereby provide fluid communication between the openings 38, 40 in the first and second ends respectively of the transition fitting 16. By virtue of the passage 18, and the method of attachment of the riser tube 14 directly to the spigot 32 of the transition fitting 16, in a manner to be described in more detail below, it will be understood that the transition fitting 16 provides a complete sealed passageway 18 for a flow of gas from the riser tube 14 to the above-ground metal piping, without the protective casing 12 having to function in any way as a gas-carrying member.

The first end 26 of the riser tube 14 is sealingly and fixedly joined to the spigot 32 of the transition fitting 16 by a first swaged joint 42, which is formed by swaging the swaging collar 20 inward, to partially compress the first end 26 of the riser tube 14 between the spigot 32 and the swaging collar 20. In the exemplary embodiment, the outer surface of the spigot 32 includes hose-barb serrations 44, and an outwardly opening annular groove 46 configured for receipt therein of a seal element in the form of a compliant O-ring 48. The hose-barb serrations 44 and O-ring 48 facilitate formation of the seal and fixed attachment of the riser tube 14 to the spigot 32 of the transition fitting 16. In other embodiments of the invention, the functions performed by the hose-barb serrations 44 and O-ring 48 may be omitted, and the functions performed thereby may be performed by other structures, depending upon the requirements for a given application.

Once the riser tube 14 is attached to the transition fitting 16 by the swaging collar 20, the second end 28 of the riser tube 14 may be fed into the protective casing 12 through the first end 22 of the casing 12, and the shouldered peripheral portion 34 of the fitting inserted into the first end 22 of the protective casing 12 to a position approximately as shown in FIG. 2, where the shoulder 36 of the transition fitting 16 substantially abuts the first end 22 of the protective casing 12.

Once the transition fitting 16 is properly positioned within the first end 22 of the protective casing 12, a second swaged joint 50 is formed by compressing a portion of the protective casing 12 against the shouldered peripheral portion 34 of the transition fitting 16, as shown in FIGS. 1 and 2. In the exemplary embodiment, an outer faying surface of the shouldered peripheral portion 34 of the transition fitting 16 includes a diamond-knurled surface treatment, to thereby provide an anti-rotation feature for precluding rotation of the transition fitting 16 within the protective casing 12 after the second swaged joint 50 is completed.

Preferably, an environmental coating is applied to the protective casing 12, prior to forming the second swaged joint 50, with the second swaged joint being accomplished without breaking through the protective coating. It will be further be appreciated, by those having skill in the art, that the hex-shaped wrenching portion 35 of the transition fitting 16, of the exemplary embodiment, allows attachment of the riser 10 to above-ground piping or a meter, without the necessity for using pipe wrenches or other gripping-jaw-type tools, which caused damage to the exterior surfaces of prior risers. The hex-shaped wrenching portion 35 of the exemplary embodiment of the riser 10, according to the invention, may be held against rotation by an open-end wrench, which will not be so likely to mar or cut through any surface coating as a pipe-wrench would, for example. Also, the transition fitting may be made of a corrosion resistant material, such as stainless steel, with the corrosion resistant properties not being lost by joining the fitting 16 to the casing 12 in the process of forming the second swaged joint 50, as compared to the degradation in corrosion resistant properties which might occur if the fitting 16 and casing 12 were to be joined together by another process, such as welding, as was the case in some prior risers.

As shown in FIG. 1, the second end 28 of the riser tube 14 in the exemplary embodiment of the riser 10 extends beyond the second end 24 of the protective casing 12, with the second end 24 of the protective casing 12 being operatively connected to an outer surface of the riser tube 14 by a third swaged joint 52, in which a portion of the protective casing 12 adjacent to the second end 24 of the protective casing 12 is swaged inward about the riser tube 14. An environmental seal is provided, at the juncture of the second end 24 of the protective casing 12, in the form of a tubular shaped ring 54 of compliant material, such as rubber or other elastomer, disposed between the outer surface of the riser tube 14 and the inner surface of the protective casing 12, with the seal 54 being fixedly held in place by the third swag joint 52.

In the exemplary embodiment, the protective casing 12, the transition fitting 16, and the swaging collar 12 are all made from a metallic material, such as steel, and the riser tube 14 is formed from a plastic material. In other embodiments of the invention, however, other appropriate materials may also be used.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A gas riser apparatus, for transporting gas from an underground plastic pipe to above-ground metal piping, the riser apparatus comprising:
a tubular-shaped protective casing having first and second ends thereof, a riser tube disposed within the protective casing and defining first and second ends thereof, a transition fitting having a fluid passage therethrough, and a swaging collar disposed about the first end of the riser tube within the protective casing;
the transition fitting having a first end thereof configured for threaded engagement with the above-ground metal piping, a second end thereof configured as a spigot for insertion into the first end of the riser tube, and a shouldered peripheral portion thereof for insertion into the first end of the casing to a depth at which a shoulder of the shouldered peripheral portion substantially abuts the first end of the protective casing, the fluid passage in the transition fitting extending through the spigot and providing fluid communication between the first and second ends of the transition fitting;
the first end of the riser tube being sealed and fixedly joined to the spigot by a first swaged joint formed by swaging the swaging collar inward to partially compress the first end of the riser tube between the spigot and the swaging collar;
the transition fitting being fixedly attached to the first end of the protective casing by a second swaged joint, formed by swaging a portion of the protective casing against the shouldered peripheral portion of the transition fitting.

2. The gas riser apparatus of claim 1, further comprising a seal-element disposed between the spigot and the first end of the riser tube.

3. The gas riser apparatus of claim 2, wherein, the spigot includes an outwardly opening annular groove therein, and the seal-element comprises a compliant O-ring substantially disposed in the annular groove.

4. The gas riser apparatus of claim 3, wherein, substantially faying surfaces of one or both of the shouldered peripheral portion and/or the portion of the protective casing forming the second swaged joint further comprises one or more anti-rotation feature(s) for precluding rotation of the transition fitting within the protective casing.

5. The gas riser apparatus of claim 4, wherein, the faying surface of the shouldered peripheral portion of the transition fitting is at least partially knurled, to thereby form at least one of the one or more anti-rotation feature(s).

6. The gas riser apparatus of claim 5, wherein, the second end of the riser tube extends beyond the second end of the protective casing, with the second end of the protective casing being operatively connected to an outer surface of the riser tube by a third swaged joint in which a portion of the protective casing adjacent the second end of the protective casing is swaged inward about the riser tube.

7. The gas riser apparatus of claim 6, further comprising, an environmental seal operatively disposed between the outer surface of the riser tube and the protective casing and fixedly held in place by the third swage joint.

8. The gas riser apparatus of claim 1, wherein the protective casing includes a protective coating applied thereto, prior to forming the second swaged joint.

9. The gas riser apparatus of claim 8, wherein, the second swaged joint is formed without damaging the integrity of the protective coating.

10. The gas riser of claim 1, further comprising, provisions for holding the riser against rotation, during attachment of the riser to a mating pipe connection using a non-gripping-jaw-type tool.

11. The gas riser of claim 10, wherein, the provisions for holding the riser against rotation comprise, wrenching flats on a portion of the transition fitting which remains exposed beyond the shoulder of the fitting following formation of the second swaged joint to affix the protective casing to the transition fitting.

12. The gas riser of claim 10, wherein, the riser includes a protective coating on exterior surfaces of the riser and the provisions for holding the riser are configured in such a manner that the integrity of protective coating is not damaged during connection of the riser.

13. The gas riser apparatus of claim 12, wherein, the provisions for holding the riser against rotation include one or more features of the transition fitting.

14. The gas riser apparatus of claim 13, wherein, the transition fitting includes wrenching flats for mating with non-gripping-jaw-type tools, such as open-end wrenches, adjustable crescent wrenches, spanner wrenches, and the like.

15. The gas riser of claim 14, wherein, the transition fitting is formed of a corrosion resistant material.

16. A method for constructing a gas riser apparatus for transporting gas from an underground plastic pipe to above-ground metal piping, the method comprising:
providing a tubular-shaped protective casing having first and second ends thereof, a riser tube disposed within the protective casing and defining first and second ends thereof, a transition fitting having a fluid passage therethrough, and a swaging collar disposed about the first end of the riser tube within the protective casing;
configuring the transition fitting to have a first end thereof adapted for threaded engagement with the above-ground metal piping, a second end thereof configured as a spigot for insertion into the first end of the riser tube, with the fluid passage in the transition fitting extending through the spigot and providing fluid communication between the first and second ends of the transition fitting;
further configuring the transition fitting to form a shouldered peripheral portion thereof for insertion into the first end of the casing to a depth at which a shoulder of the shouldered peripheral portion substantially abuts the first end of the protective casing, the fluid passage in the transition fitting extending through the spigot and providing fluid communication between the first and second ends of the transition fitting;
inserting the spigot into the first end of the riser tube, disposing the swaging collar around the riser tube opposite the spigot, and swaging the swaging collar inward to partially compress the first end of the riser tube between the spigot and the swaging collar, to thereby seal and fixedly join the first end of the riser tube to the spigot;
inserting the second end of the riser tube through the first end of the protective casing;
following formation of the first swaged joint, inserting the shouldered peripheral portion of the transition fitting into the first end of the casing to a depth at which a shoulder of the shouldered peripheral portion substantially abuts the first end of the protective casing; and
fixedly attaching the transition fitting to the first end of the protective casing by swaging a portion of the protective casing adjacent the first end of the casing against the shouldered peripheral portion of the transition fitting, to thereby form a second swaged joint.

17. The method of claim 16, further comprising, sealingly disposing a seal-element between the spigot and the first end of the riser tube.

18. The method of claim 17, wherein, the spigot includes an outwardly opening annular groove therein, the seal-element comprises a compliant O-ring substantially disposed in the annular groove, and the method further comprises, installing the O-ring in the annular groove prior to inserting the spigot into the first end of the riser tube.

19. The method of claim 16, further comprising, at least partially knurling a faying surface of the shouldered peripheral portion of the transition fitting, to thereby form at least one of the one or more anti-rotation feature(s).

20. The method of claim 16, further comprising configuring the riser tube such that the second end thereof extends beyond the second end of the protective casing, and operatively connecting an outer surface of the riser tube to the protective casing by a swaging a portion of the protective casing adjacent the second end of the protective casing inward about the riser tube, to form a third swaged joint.

21. The method of claim 20, further comprising, forming an environmental seal operatively disposed between the outer surface of the riser tube and the protective casing and fixedly held in place by the third swaged joint.

22. A gas riser apparatus, for transporting gas from an underground plastic pipe to above-ground metal piping, the riser apparatus comprising:
a tubular-shaped protective casing having first and second ends thereof, a riser tube disposed within the protective casing and defining first and second ends thereof, a transition fitting having a fluid passage therethrough, and a swaging collar disposed about the first end of the riser tube within the protective casing;
the transition fitting having a first end thereof configured for threaded engagement with the above-ground metal piping, a second end thereof configured as a spigot for insertion into the first end of the riser tube, and a shouldered peripheral portion thereof for insertion into the first end of the casing to a depth at which a shoulder of the shouldered peripheral portion substantially abuts the first end of the protective casing, the fluid passage in the transition fitting extending through the spigot and providing fluid communication between the first and second ends of the transition fitting;
the first end of the riser tube being sealed and fixedly joined to the spigot by a first swaged joint formed by swaging the swaging collar inward to partially compress the first end of the riser tube between the spigot and the swaging collar;
the transition fitting being fixedly attached to the first end of the protective casing by a second swaged joint, formed by swaging a portion of the protective casing against the shouldered peripheral portion of the transition fitting, with substantially faying surfaces of one or both of the shouldered peripheral portion and/or the portion of the protective casing forming the second swaged joint further comprises one or more anti-rotation feature(s) for precluding rotation of the transition fitting within the protective casing.

23. The gas riser apparatus of claim 22, wherein, the faying surface of the shouldered peripheral portion of the transition fitting is at least partially knurled, to thereby form at least one of the one or more anti-rotation feature(s).

24. The gas riser apparatus of claim 22, wherein, the second end of the riser tube extends beyond the second end of the protective casing, with the second end of the protective casing being operatively connected to an outer surface of the riser tube by a third swaged joint in which a portion of the protective casing adjacent the second end of the protective casing is swaged inward about the riser tube.

25. The gas riser apparatus of claim 24, further comprising, an environmental seal operatively disposed between the outer surface of the riser tube and the protective casing and fixedly held in place by the third swage joint.

26. The gas riser of claim 25, further comprising, provisions for holding the riser against rotation, during attachment of the riser to a mating pipe connection using a non-gripping-jaw-type tool.

27. The gas riser of claim 26, wherein, the provisions for holding the riser against rotation comprise, wrenching flats on a portion of the transition fitting which remains exposed beyond the shoulder of the fitting following formation of the second swaged joint to affix the protective casing to the transition fitting.
